(19) United States
(12) Patent Application Publication
(10) Pub. No.: US 2003/0193565 A1
(43) Pub. Date: Oct. 16, 2003

(54) Method and apparatus for visually measuring the chromatic characteristics of a display

(76) Inventor: Senfar Wen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/118,998

(22) Filed: Apr. 10, 2002

(51) Int. Cl. H04N 17/02

(52) U.S. Cl. 348/184; 348/182

(57) ABSTRACT

A method for visually measuring the chromatic characteristics of a display is disclosed, which includes the measurement of the tonal response curves of the primaries and the white point of the display. For a primary, the luminance of a uniform luminance pattern and the average luminance of a non-uniform luminance pattern are visually adjusted so that they are equal, in which the non-uniform luminance pattern comprises interlaced pixels with several different luminance levels. From several such testing patterns the characterization parameters of the tonal response curve of the primary can be obtained. Accurate white point of a display can be measured by selecting a unique gray color of kwon chromaticity coordinate in a sequence of graphic user interfaces if the provided chromaticity characteristics of the primaries are accurate

### FIELD OF THE INVENTION

The present invention relates in general to a method and apparatus for measuring the chromatic characteristics of a display. In particular, the present invention relates to a method and apparatus for visually measuring the chromatic characteristics and without the use of color matching cards or the hardware meters such as calorimeter, spectroradiometer, and photometer. More particularly, the present invention relates to a method and apparatus for measuring the tonal response curves (TRCs) of the primary colors, where the TRC model can be described by any kind of function, and accurate white point of a display if the provided chromaticity characteristics of the primaries are accurate.

### BACKGROUND OF THE INVENTION

A color display usually consists of red, green, and blue primaries. High-fidelity color picture can be re-generated with the display if the chromatic characteristics of the display are well understood. The chromatic characteristics include the chromaticity coordinates and TRCs of the primaries, and white point. A color display shows white color when its RGB video inputs are of the same value. The chromaticity coordinate of the white color is called the white point. The white point is determined by the relative luminance among the primaries. For example the standard ITU-R BT.709 for color displays designates the white point as x=0.3127 and y=0.3291. However, usually several white point options are provided for a computer monitor. The TRC is the relation of the luminance of a primary color and the video voltage. For example, the TRC of a CRT display can be described by a power function, which is known as gamma model and can be expressed as Luminance=[Video Voltage]^{γ}, where gamma γ is a constant.

The chromaticity coordinates of the primaries of a CRT display are fixed if there is no crosstalk among the primaries. If its tube type, e.g. Sony Trinitron, or phosphor, e.g. P22, is known, the chromaticity coordinates of primaries can be known. Usually the chromaticity coordinate of the white point of a display either follows a standard or can be known by the color temperature setting of the monitor. However in practice different display manufacturers usually set different chromaticity coordinates for the same so called color temperature, such as 6500K and 9300K. Nowadays, the chromaticity characteristics of a display are recorded in the extended display identification data (EDID) memory embedded in most computer monitors. EDID is a standard of Video Electronics Standards Association (VESA). The white point recorded in EDID is the default setting of the monitor. There is a gamma value of TRC stored in EDID. However, the value it is usually incorrect because the change of brightness and contrast setting of the display may change the gamma value; besides the three gamma values of the red, green, and blue primaries may not be the same.

In some instances the chromaticity characteristics of a display are required to be measured. For the TRC, it is required to be measured when (1) there is no EDID in the display, (2) the gamma value in EDID is incorrect, (3) a user changes brightness and contrast setting, and (4) the display ages. For the white point, it is also required to be measured when (1) there is no EDID in the display, (2) the chromaticity coordinate of the white point recorded in EDID is incorrect, (3) a user changes white point setting, and (4) the display ages.

The chromatic characteristics can be measured with the hardware meters such as colorimeter and spectroradiometer. As the hardware meters are expensive, the measurement is usually carried out by display manufacturers or by professional users. On the other hand there are visual methods used to measure the chromaticity characteristics, which include white point and TRCs, without apparatus. The chromaticity coordinates of the primaries cannot be visually measured. If there is EDID in the display, chromaticity coordinates of the primaries in EDID can be used. If there is no EDID, chromaticity coordinates of the primaries can be assumed according to a color standard, such as ITU-R BT.709, or according to the type or phosphor if the display under test is CRT. Although the measurement with visual methods is not as accurate as that with meters, it is a cheap and convenient solution. The visual methods present a short series of color images to the user and collects feedback via a graphic user interface (GUI). The white point and TRCs can be calculated from the feedback. The principles of the visual methods are described below.The TRC of a primary can be visually measured for examples with the methods disclosed in U.S. Pat. Nos. 5,638,117 and 6,078,309. Such methods use a dithering method to generate the GUI patterns. A sequence of test patterns is shown by the display. Each test pattern comprises a uniform luminance region (ULR) and a non-uniform luminance region (NULR). The luminance of the ULR is adjusted through changing the video voltage so that it visually matches the luminance of the NULR. The luminance of the NULR is set by dithering method, where the NULR comprises pixels of the maximum luminance interlaced with pixels of the minimum luminance (black). The maximum luminance corresponds to the maximum video voltage. If the viewing condition is below the visual acuity of the observer, the NULR is observed to be uniform and its observed luminance is equal to the average luminance of the ULR. For example, if the numbers of the bright pixels and black pixels are equal, the observed luminance is equal to half the maximum luminance of the primary. In the following, the average luminance of NULR is called the reference luminance and the luminance of NULR is called the testing luminance. As the reference luminance is known, if TRC can be described by simple gamma model, one can easily calculate the value of gamma from the video voltage of the testing luminance that matches reference luminance. For the TRC model with more than one characterization parameter, more measurements with different reference luminance are required. Additional reference luminance can also be set by dithering method in principle. The visually measuring methods have the drawbacks. (1) The observer has to squint hard to blur his vision or stay far away from the display due to high visual acuity so that the dithering pattern of NULR can be observed to be uniform (2) Testing luminance is possibly mismatched to the reference luminance when the NULR is not observed to be uniform. (3) The number of usable reference luminance is limited and therefore the number of TRC characterization parameters is limited accordingly. The reference luminance is proportional to the ratio of the number of bright pixels and the total number of bright pixels and black pixels in the NULR. To improve viewing condition so that the dithering pattern can be easily observed to be uniform, the ratio cannot be too small, i.e. the lowest reference luminance is limited by viewing condition. In practice, even for the dithering pattern with the same number of bright pixels and black pixels, the testing luminance is hard to match the reference luminance.

The white point can be visually estimated with the methods disclosed in U.S. Pat. Nos. 6,023,264 and 6,078,309. Basically such methods request a user select a gray patch looks “most neutral gray” from a sequence of gray patches, in which each patch correlates to a point in a white point axis. Usually the color temperature line is selected as the white point axis. The correlated color temperature of white point can be calculated from the chromaticity characteristics of primaries, the correlated color temperature of the selected gray patch, and a given correlated color temperature for the color of “most neutral gray”. However these methods estimate the correlated color temperature of white point but not the accurate chromaticity coordinate of white point.

### SUMMARY OF THE INVENTION

It is therefore the objective of the present invention to provide a method and apparatus for visually measuring the chromatic characteristics of a display, which can be CRT display, LCD, or any other kind of display technology. In the present invention, the drawbacks of the previous visually measuring method are overcome.

A method is disclosed to set the reference luminance of NULR so that viewing condition for observing uniform dithering pattern can be easily satisfied and the setting of the reference luminance is less constrained. The NULR comprises interlaced pixels with several different luminance levels so that the spatial frequency of the luminance levels is high and the contrast ratio of the luminance levels is low. Thus the luminance of such a NULR is more easily observed to be uniform for a user. In addition the number of the characterization parameters of the TRC model with this method can be more than that with the conventional method.

Furthermore a method for visually measuring the chromaticity coordination of white point is disclosed. Accurate white point of a display can be measured by selecting a unique gray color of kwon chromaticity coordinate in a sequence of graphic user interfaces if the provided chromaticity characteristics of the primaries are accurate. The unique color does not appear the color components around the white area of the chromaticity diagram and therefore can be called the neutral white or neutral gray. The rule to choose the neutral gray is simple. For example, if a CIE chromaticity system is used, for the neutral gray, increasing its x coordinate results in appearing yellowish or pinkish, decreasing its x coordinate results in appearing greenish or bluish, increasing its y coordinate results in appearing greenish, and decreasing its y coordinate results in appearing purplish. Therefore the neutral gray can be uniquely identified. Two methods can be used to find the neutral gray but the chromaticity coordinates and TRCs of the primaries have to be given. One is to set a trial white point of the display and to show a chromaticity diagram or color patches that correspond to a plurality of chromaticity coordinates according to the chromaticity characteristics of the primaries and the assumed white point of the display. The other is to show a diagram or color patches that correspond to the same chromaticity coordinate of the neutral gray while the video inputs of the color are according to the chromaticity characteristics of the primaries and a plurality of assumed white points of the display. From the selected color point on the diagram or the selected color patch for the either method, the white point of the display can be obtained.

### BRIEF DESCRIPTION OF THE DRAWINGS

FIG. 1 illustrates an example of NULR with two different kinds of luminance levels.

FIG. 2 illustrates the cases of (a) ULR 3 is surrounded by NULR 4 and (b) NULR 4 is surrounded by ULR 3.

FIG. 3 illustrates (a) the chromaticity triangle and (b) a portion within the triangle.

FIG. 4 illustrates (a) the chromaticity diagram with CIE (x, y, Y) coordinate and (b) the chromaticity diagram with CIE (L*, a*, b*) coordinate.

FIG. 5 illustrates an example for the arrangement of color patches to help a user select an accurate (xus, yus), in which the color patch at the i-th column and j-th row corresponds to the coordinate (xi, yj).

FIG. 6 illustrates (a) a box and (b) a gray ramp that show the color of the selected neutral gray point (xus, yus).

FIG. 7 illustrates a GUI to help a user select the most neutral gray patch, which include a gray ramp 22, direction symbols 24 or 26, and a position map 28.

FIG. 8 illustrates the diagrams with (a) CIE (x, y, Y) coordinate and (b) CIE (L*, a*, b*) coordinate, in which their coordinate axes are the assumed white point of the display and their pixel color is generated so that it is assumed to be of the chromaticity coordinate (xu, yu,Y) for the display of the white point (xwa, ywa), in which Y is the same for all pixels.

FIG. 9 illustrates a apparatus comprising the hardware devices for implementing the methods disclosed in this invention.

FIG. 10 illustrates a apparatus comprising the hardware devices for implementing the methods disclosed in this invention.

### DETAILED DESCRIPTION OF THE PREFERRED EMBODIMENT

This invention discloses a method and apparatus for visually measuring the TRCs of primaries and the white point of a display without the help of hardware meters. The methods for measuring the TRCs and white point are separately described in detail in the followings. The apparatus for implementing the disclosed methods is also described. The present invention is described hereinafter with reference to the accompanying drawings, in which a preferred embodiment of the invention is shown. This invention may be embodied in many different forms and should not be constructed as limited to the embodiments set forth herein.

TRC Measurement

The TRC of a primary is designated as R(v), where v is video voltage and the maximum video voltage is V. In a computer apparatus the video voltage is digitized as

$$v = m \frac{V}{{2}^{″} - 1} , m = 0 , 1 , 2 , … , {2}^{n} - 1 , \qquad ( 1 )$$

where n is the number of bits to represent the voltage level. The TRC model is characterized by some numerical parameters according to the assumed function form of R(v), which are called the characterization parameters. For example, the gamma model with offset voltage is usually used for the TRC of CRT display, which can be written as

R(v)=A(v+α)^{γ}. (2)

The characterization parameters for Equation (2) are α and γ. The parameter A can be determined by the normalization condition R(V)=1. Today liquid crystal display (LCD) is popular. Its TRC is not fitted well with the gamma model. The Taylor series expansion of R(v) is more proper, though more coefficients are required, which can be written as a polynomial as

R(v)=c₀+c₁v+c₂v²+c₃v³+ (3)

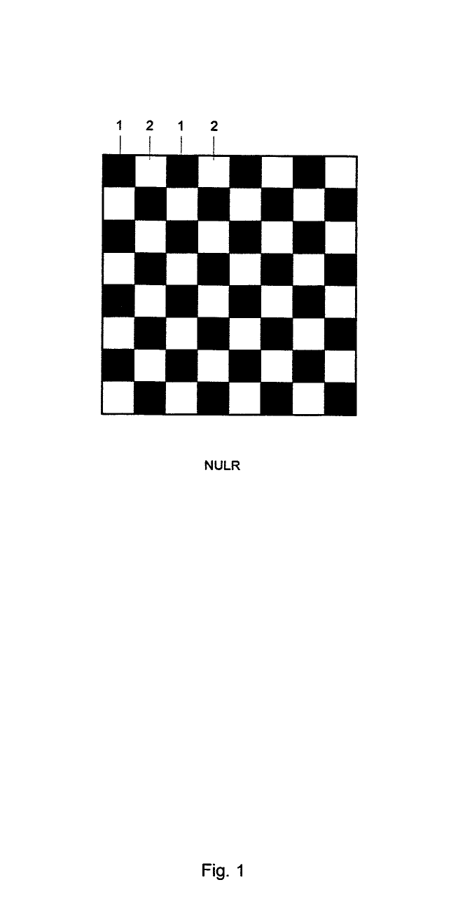

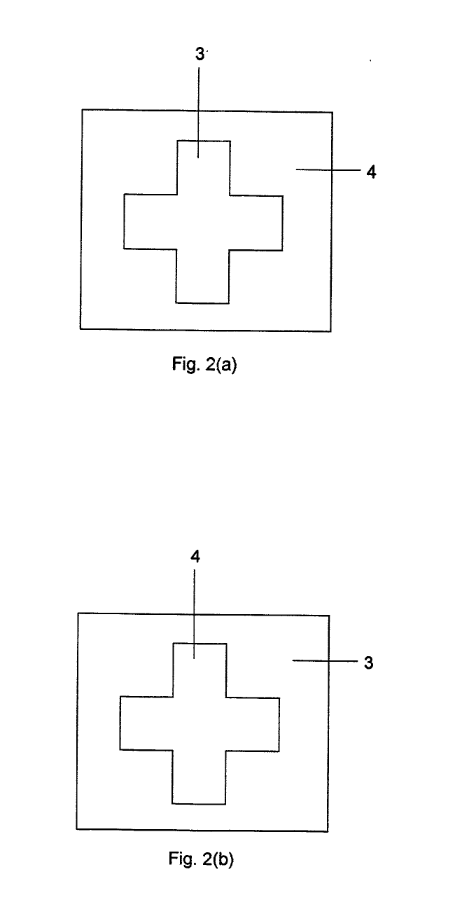

Assume that the number of characterization parameter is Nc. For the conventional method for visually measuring the TRC, the display shows a sequence of test patterns. Each pattern comprises a ULR and a NULR, where the luminance of the NULR is set by dithering method. For the NULR, bright pixels of luminance R(V) are interlaced with black pixels so that its average luminance can be easily calculated and it is R(V)N1/(N1+N0), where N1 and N0 are the numbers of bright pixels and black pixels respectively. Then the user visually adjusts the video input of the ULR so that the observed boundary between the ULR and NULR disappears. In such an instance the luminance of the ULR and NULR are matched and the relation R(v)=R(V)N1/(N1+N0) is obtained for the test pattern. However there are the drawbacks for this conventional method as is described in the background of this invention. A method is disclosed to set the average luminance of the NULR so that the drawbacks are avoided. In the present invention, NULR comprises interlaced pixels of different luminance, which can be nonzero. A simple example is shown in FIG. 1, where the pixels of two kinds of luminance 1 and 2 are interlaced. FIG. 2(a) and FIG. 2(b) show two simple examples for the arrangements of ULR and NNULR. In FIG. 2(a) ULR 3 is surrounded by NULR 4. In FIG. 2(b) NULR 4 is surrounded by ULR 3. Therefore the NULR can be much more easily observed to be uniform than the conventional method because of much lower contrast ratio of the different luminance levels and, in addition, the setting of the average luminance of NULR is less constrained. If NULR comprises M kinds of luminance, its average luminance is

$${R}_{avg} = {\sum }_{j = 1}^{M} {n}_{j} R ( {v}_{j} ) / {\sum }_{j = 1}^{M} {n}_{j} , \qquad ( 4 )$$

where nj and vj are the number of pixels and video voltage of the j-th kind of luminance in NULR. Different from the previous method, since R(vj) in Equation (4) is not yet known, the average luminance of NULR is unknown during measurement for the present invention. For the present invention, the display shows a sequence of different test patterns. Each pattern comprises ULR and NULR. By visually adjusting the input voltage of ULR, one can match the luminance of ULR and NULR for each test pattern. Thus we have the set of equations

$$R ( {v}_{i} ) = {\sum }_{j = 1}^{{M}_{i}} {n}_{ij} R ( {v}_{ij} ) / {\sum }_{j = 1}^{{M}_{i}} {n}_{ij} , \qquad ( 5 )$$

where vi is the video voltage of the ULR of the i-th test pattern; Mi is the number of different luminance in the NULR of the i-th test pattern; and nij and vij are the number of pixels and video voltage of the j-th luminance in the NULR of the i-th test pattern. Therefore one can obtain the characterization parameters of R(v), for example in a least square fitting sense, from Equation (5). To obtain the characterization parameters, it requires that the number of test patterns is no less than Nc.

An example procedure for measuring the TRC of a primary with the method disclosed above is described below.

Step 1-1: Set a TRC model, the number of test pattern Nt, the number of different luminance in the NULR of the i-th test pattern Mi, the set of integer number mij and nij (i=1, 2, . . . , Nt and j=1, 2, . . . , Mi) defined in Equation (5), in which mij corresponds to the video voltage vij=mijV/(2ⁿ−1) for the NULR, the set of integer number li (i=1, 2, . . . , Nt) which corresponds to the video voltage vi=liV/(2ⁿ−1) for the ULR, and i=1.

Step 1-2: Set 1=li.

Step 1-3: Show the i-th test pattern on the display. The test pattern includes ULR, in which the input voltage IV/(2ⁿ−1) is the same for all the pixels, and NULR, which surrounds the ULR or is surrounded by ULR.

Step 1-4: Request a user adjust l through a human-computer interface such as a mouse or a keyboard until the average luminance of ULR matches that of NUBR. The luminance matching means that the two regions cannot be visually distinguished.

Step 1-5: If i=Nt, go to Step 1-6, else i=i+1 and go to Step 1-3.

Step 1-6: Compute characterization parameters of the TRC from the set of equations given in Equation (5).

Step 1-7: Stop.

The advantages of the disclosed method for measuring TRC are described as follows.

(1) As it is easier to match the luminance of ULR and NULR, accurate TRC can be measured if proper TRC model is used for the display. Because it is hard to match the luminance of ULR and NULR for the convention method, a user may misjudge the video voltage of ULR and this results in inaccurate TRC.

(2) As many test patterns of different combinations of the parameters in Equation (5) can be used for the visual luminance matching of ULR and NULR, accurate TRC model with many characterization parameters can be used, such as the polynomial model given by Equation (3) or the other kinds of suitable function for the display. The number of the characterization parameters for the convention method with dithering pattern for NULR is limited by the usable test patterns that are easy for the visual luminance matching of ULR and NULR.

From the characteristics of the test patterns described above, there are two extensions to the measurement method described above. The first is to keep the luminance of ULR unchanged and a user adjusts the average luminance of NULR by changing the parameters in Equation (5) so that the luminance of ULR and NULR are matched. The second is to replace the ULR by a NULR, i.e. two NULRs are used as the test patterns, in which the parameters of the two NULR's are different. The user changes the average luminance of one of the NULR to match the average luminance of the other NULR. The procedure for the two approaches are similar to the procedure described above.

White Point Measurement

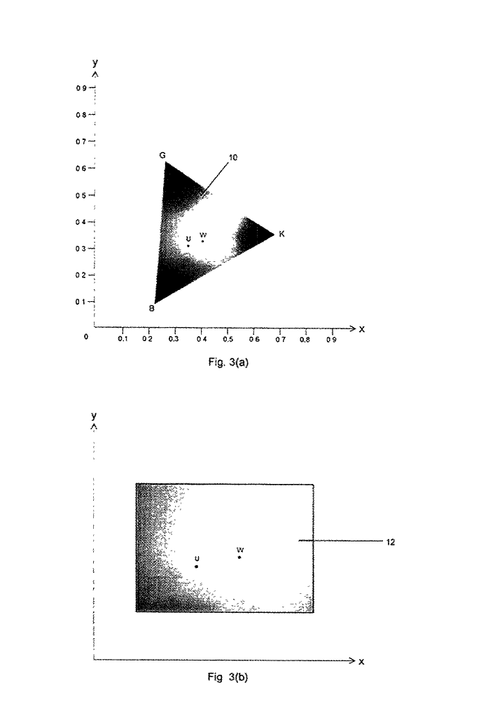

The disclosed method visually measuring white point in the present invention is based on finding a unique point of known chromaticity coordinate as is shown in FIG. 3(a) and FIG. 3(b), where the point U represents the unique point and the point W represents the white point. FIG. 3(a) shows the chromaticity triangle 10, in which its apexes, R, G, and B points, correspond to the three primaries. The chromaticity coordinates of the red, green, and blue primaries are designated as (xr, yr), (xg, yg), and (xb, yb), respectively. The chromaticity coordinates of the U point and white point of the display are designated as (xu, yu) and (xw, yw) respectively. FIG. 3(b) shows a portion 12 within the chromaticity triangle 10 with which user can be more easily to indicate the U point. U point appears neutral gray to a user, which lies among the red, green, and blue areas. Its chromaticity coordinate is similar to most users because the spectral response curves of the observers, who are not colorblind, are minor. The procedure of the disclosed method for visually measuring the white point is described in more detail with the following steps.

Step 2-1: Set (xu, yu) and the chromaticity coordinates and TRCs of the primaries of the display; set a trial chromaticity coordinate of the white point of the display, in which the trial white point is designated as (xwt, ywt), for example (xwt, ywt)=(0.3127, 0.3291); and set the coordinate range of the chromaticity diagram to be shown in which the central coordinate is (xc, yc), for example (xc, yc)=(xu, yu).

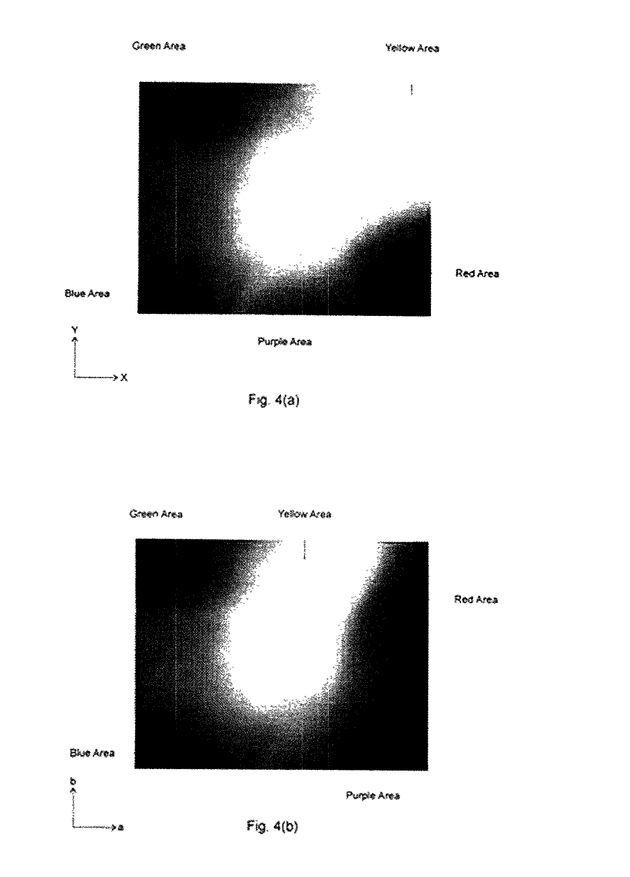

Step 2-2: Display a chromaticity diagram, such as CIE (x, y, Y) chromaticity diagram shown in FIG. 4(a) or CIE (L*, a*, b*) chromaticity diagram shown in FIG. 4(b), on the display under test, in which the display is assumed to be of white point (xwt, ywt) and of the primaries given in Step 2-1; and the luminance coordinate Y or L* is taken to be the same for all pixels of the diagram.

Step 2-3: Request a user select a point of neutral gray from the chromaticity diagram through a human-computer interface such as a mouse or a keyboard, where the chromaticity coordinate of the selected neutral gray is designated as (xus, yus).

Step 2-4: Compute (xw, yw) according to (xus, yus), (xwt, ywt), (xu, yu), and the chromaticity coordinates of the primaries of the display.

Step 2-5: Stop

In Step 2-1, the neutral gray point (xu, yu) is empirically pre-determined by experiment and is accurately measured by a spectroradiometer, which is an average result for a group of observers.

The chromaticity diagram displayed in Step 2-2 is not restricted to the CIE chromaticity diagrams. The other chromaticity diagrams, which has similar characteristics described in Step 2-2, can also be used. In Step 2-2, the video input for every point of coordinate (x, y, Y) on the diagram is according to the chromaticity coordinates and TRC's of the primaries, and the trial white point (xwt, ywt). The luminance Y is taken as the same for all the pixels of the diagram to avoid the mistake of color perception because brighter luminance is perceived to be more close to white. It is also noticed that the pixel color usually is not (x, y, Y) because the trail white point (xwt, ywt) given in Step 2-1 does not happen to be the real white point (xw, yw). Therefore the luminance Y for every pixel is in fact not the same for all pixels. However this does not affect the result because (xw, yw) does not depend on Y and, if the Steps 3-1 to 3-6 or Steps 4-1 to 4-2 described below are used to converge the selection of (xus, yus) to accurate result, the luminance Y of shown color patches approaching the final selection are slightly different.

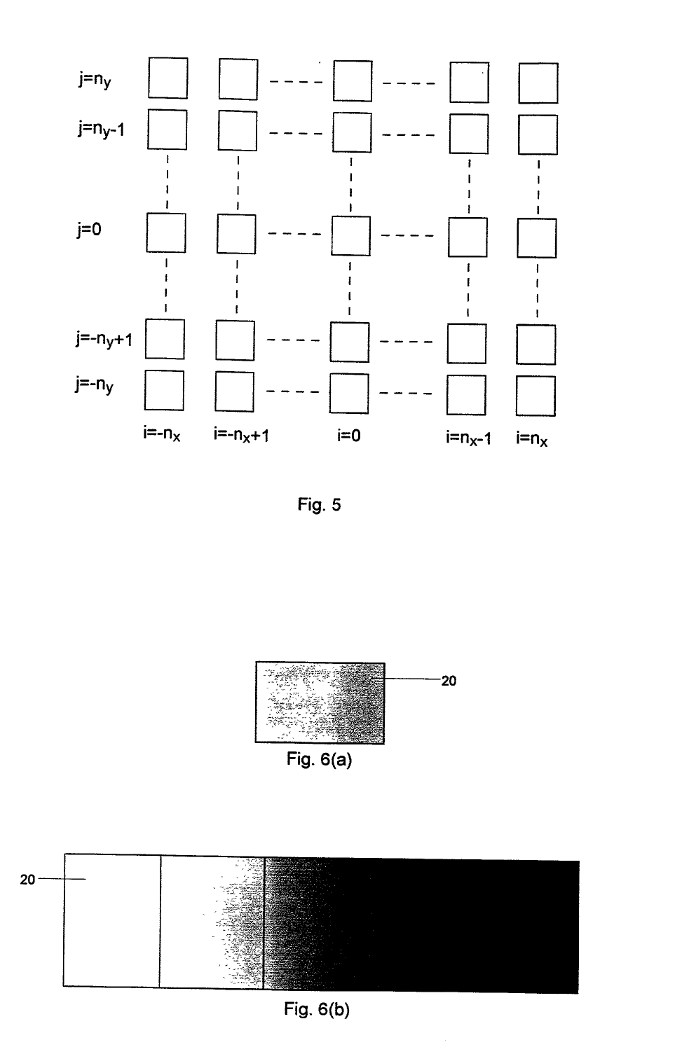

The other possible approach is to show a set of properly arranged color patches so that a user is easier to select the color of neutral gray, where each color patches corresponds to a chromaticity coordinate (x, y, Y). As the number of color patches is limited, the selection process requires several loops to converge (xus, yus) to accurate result. A simple arrangement is shown in FIG. 5, where the color patch at the i-th column and j-th row corresponds to the coordinate (xi, yj) and

xᵢ=x₀+iΔx

yⱼ=y₀+jΔy (6)

where (x0, y0) is a reference coordinate; Δx and Δy are the spacing in the x and y coordinate axes respectively; i=−nx, −nx+1, . . . , nx−1, nx; and j=ny, −ny+1, . . . , ny−1, ny. The following procedure can be used to replace Step 2-2 and Step 2-3 for converging the selected color to accurate result is described below for example.

Step 3-1: Set the initial values, which are a coordinate (x′us, y′40 us)=(xc, yc), the minimum coordinate spacing δ, Δx, Δy, nx, and ny.

Step 3-2: Set (x0, y0)=(x′us, y′us).

Step 3-3: Show (2nx+1)+(2ny+1) color patches, in which each corresponds to the coordinate (xi, yj, Y) given in Equation (6) and Y is the same for all color patches.

Step 3-4: Request a user select a patch from the patches given in Step 3-3 through a human-computer interface such as a mouse or a keyboard, in which the patch looks the most close to neutral gray and the coordinate of the patch is designated as (x″us, y″us).

Step 3-5: If the norm |(x″us, y″us)−(x′us, y′us)|≦δ, then go to the next step else

(x′us, y′us)=(x″us, y″us),

Δx=2Δx/(2nx+1),

Δy=2Δy/(2ny+1),

and go to Step 3-2.

Step 3-6: (xus, yus)=(x″us, y″us).

The smaller δ given in Step 3 -1, the more accurate (xus, yus) but the number of selection loops increases. When the number of color patches is too much in a loop, a user may be confused in the selection especially when the color characteristics of different portions of the display is not uniform due to aging, for example the upper portion shows slightly reddish than the lower portion for the same video input. In the procedure, the number nx and ny can be decreased with Δx and Δy so that the number of patches for a user to select is reduced and the area occupied by all the patches on the display is less and can be compactly placed on the central part of the display. To reduce the number of selection loops, one can combine the GUIs used in Steps 2-2 to 2-3 and Steps 3-1 to 3-6, for an example first using chromaticity diagram to select a neutral gray and then using the color patches for more accurate selection.

In Steps 2-2 to 2-3 or Steps 3-1 to 3-6, the selected color may not be the real neutral gray because (1) the selected (xus, yus) in Step 2-3 may be not accurate enough, and (2) the chromaticity characteristics of primaries taken in Step 2-1 may be not accurate enough especially for the TRCs of the primaries. Two steps can be further added following Step 2-3 or 3-6 to guarantee the selected color is really the most close to neutral gray.

Step 4-1: Specify the spaces δx and δy for x and y color coordinates.

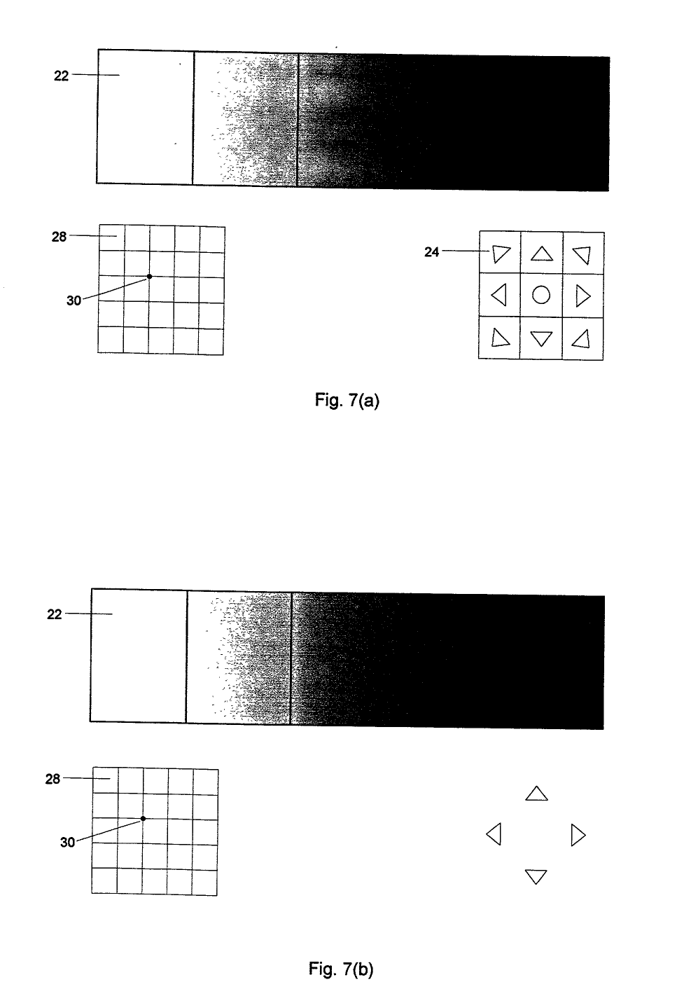

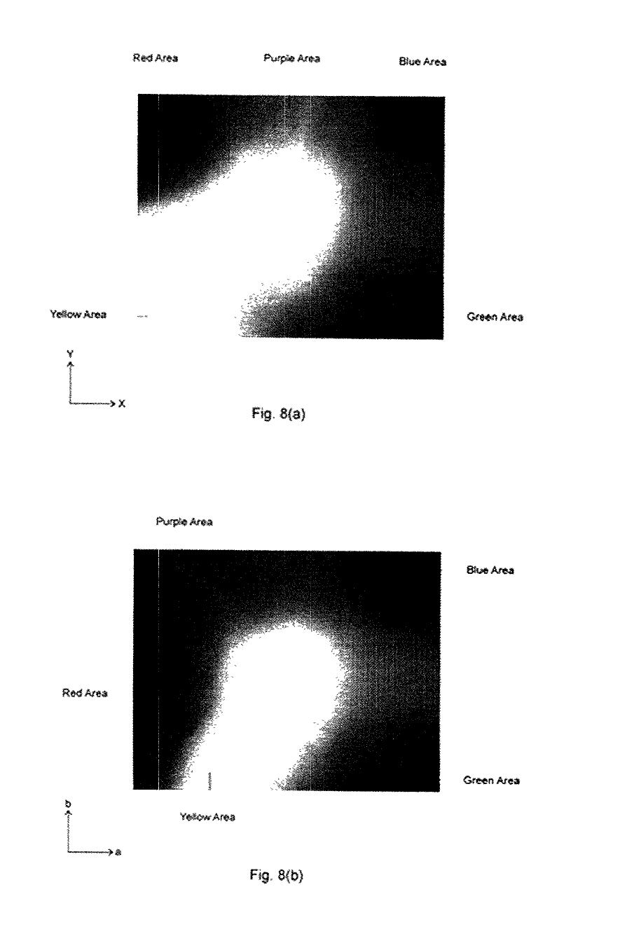

Step 4-2: Display a box 20 or a gray ramp 22 showing the color of the selected neutral gray (xus, yus), in which the gray ramp 22 comprises a sequence of small boxes with different gray levels such as the example shown in FIG. 6(b).

Step 4-3: Request a user change (xus, yus) with the spaces of δx and δy until the box looks neutral gray through a human-computer interface such as a mouse or a keyboard.

When the chromaticity characteristics of primaries taken in Step 2-1 are not accurate enough, different gray levels in the gray ramp may show different hue and saturation. Therefore the use of the gray ramp has the advantage to select a compromised (xus, yus). The neutral gray means that it does not appear the color components around the white area of the chromaticity diagram. For example, if a CIE chromaticity apparatus is used, an easy rule to choosing the neutral gray is described below. For the neutral gray, increasing its x coordinate results in appearing yellowish or pinkish, decreasing its x coordinate results in appearing greenish or bluish, increasing its y coordinate results in appearing greenish, and decreasing its y coordinate results in appearing purplish. Therefore the neutral gray can be uniquely identified. The increment or decrement of x and y coordinate for (xus, yus) can be with the arrow keys on a keyboard or with the GUI as is shown in FIG. 7(a) or FIG. 7(b), in which a user clicks the arrow symbols 24 or 26 with a mouse to increase or decrease x and y coordinate. In FIG. 6(a) and FIG. 6(b), a chromaticity position map 28 can be provided to indicate the current position of (xus, yus) with a highlight symbol 30.

In Step 2-4, (xw, yw) can be computed from the relations

xᵤ(x_{w},y_{w},xᵣ,yᵣ,x_{g},y_{g},x_{b},y_{b},x_{wt},y_{wt},xᵤₛ,yᵤₛ)=xᵤ, (7a)

yᵤ(x_{w},y_{w},xᵣ,yᵣ,x_{g},y_{g},x_{b},y_{b},x_{wt},y_{wt},xᵤₛ,yᵤₛ)=yᵤ. (7b)

The left hand sides of Equations (7a) and (7b) are the functions of the chromaticity coordinates of neutral gray xu and yu in terms of xw, yw, xr, yr, xg, yg, xb, yb, xwt, ywt, xus, and yus. Since there are only two unknown xw and yw in the two equations, xw and yw can be exactly solved.

The other similar procedure to visually measuring white point is to show the diagram similar to chromaticity diagram described above but its two coordinate axes are taken to be the x and y components of the trial white point of the display, which are designated as xwa and ywa, respectively. The color of the pixel of coordinate (xwa, ywa) is generated so that it is assumed to be of chromaticity coordinate (xu, yu) for the display of the white point (xwa, ywa). Thus all pixels do not show neutral gray except the pixel of coordinate (xwa, ywa)=(xw, yw). With a human-computer interface to indicate the pixel of neutral gray, the white point (xw, yw) of the display is found. The procedure is described below in detail.

Step 5-1: Set (xu, yu) and the chromaticity coordinates and TRCs of the primaries of the display; and set the coordinate range of the diagram to be shown, in which the central coordinate is (xwac, ywac), for example (xwac, ywac)=(0.3127, 0.3291).

Step 5-2: Display a diagram with coordinate axes (xwa, ywa) on the display under test, such as is shown in FIG. 8(a) or FIG. 8(b), in which the input video voltages of the pixel designated as (xwa, ywa) are generated so that its chromaticity coordinate is taken to be (xu, yu, Y) for the display which is assumed to be of white point (xwa, ywa) and of the primaries given in Step 5-1; and Y is the same for all pixels of the diagram.

Step 5-3: Request a user select a pixel of neutral gray from the diagram through a human-computer interface such as a mouse or a keyboard, where the chromaticity coordinate of the selected neutral gray is designated as (xwas, ywas).

Step 5-4: (xw, yw)=(xwas, ywas).

Step 5-5: Stop

There are the similar steps as Steps 3-1 to 3-6 for this method to help a user select the color of neutral gray with color patches, where the coordinate (xi, yj) is replaced by (xwai, ywaj), the subscript “us” of the symbols is replaced by “was”, and the initial (x0, y0) can be taken as (0.3127, 0.3291) for example. There is also the method with the combined GUIs used in Steps 5-2 to 5-3 and the color patches method to reduce the number of selection loops, for example first using the diagram to select a pixel of neutral gray and then using the color patches for more accurate selection.

Apparatus Implementation

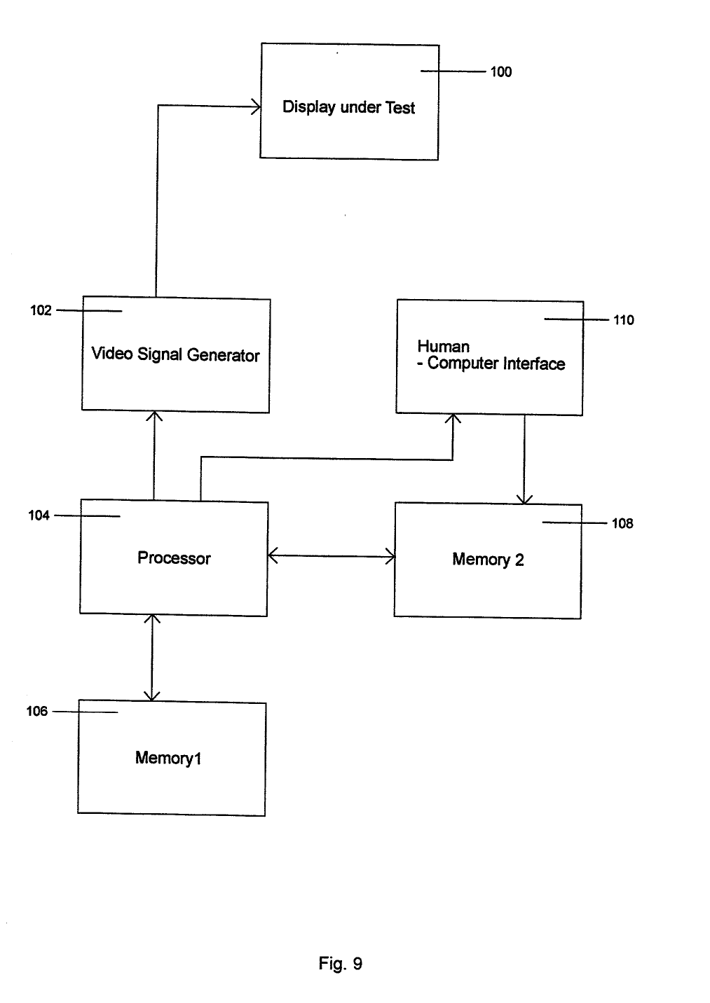

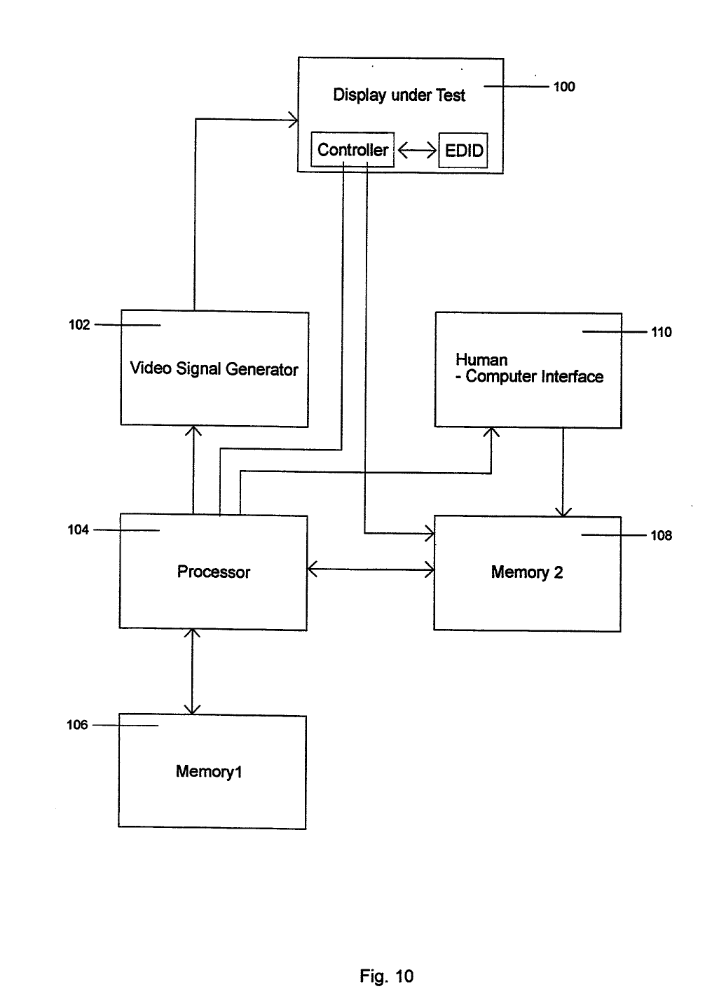

Although no hardware meters are required, the measurement process of this invention requires a apparatus shown in FIG. 9 comprising the devices that are able to generate video voltage, to receive the response of a user, to calculate the numerical data, and to store data. The pre-setting numerical parameters and the programs for generating the necessary GUIs and calculating the numerical results are stored in the memory 106. The processor 104 archives the data and program from the memory 106 and outputs the data of a GUI to the video signal generator 102. The video signal generator converts the data from the processor 104 to the input of the display 100 under test. A user responds to the GUI through the human-computer interface 110, which may be a mouse or a keyboard. The human-computer interface 110 sends the response of the user to the memory 108. Then processor 104 accesses the response stored in the memory 108. After several loops of such operations, the measurement process is completed and the processor calculates either the characterization parameters of the TRCs or the white point. The results are stored in the memory 106. The memory 106 and memory 108 can be designed to be the same memory device. If there is an EDID in the display 100 under test, the processor 104 may archive the data through the controller of the display as the apparatus shown in FIG. 10.

What is claimed is:

1. A method and apparatus for visually measuring the chromatic characteristics of a display, measuring the characterization parameters of a given model R(v) of the tonal response curve for a primary of a display, which comprising the steps of:
(a)setting a number of testing patterns in which each including a uniform luminance region (ULR) and a non-uniform luminance region (NULR), in which the NULR including interlaced pixels of different luminance;
(b)requesting a user adjust the video input of the ULR for each test pattern so that the observed boundaries of the ULR and the NULR disappear; and
(c)computing the characterization parameters of the tonal response curve that most satisfy the set of equations:
$$R ( {v}_{i} ) = {\sum }_{j = 1}^{{M}_{i}} {n}_{ij} R ( {v}_{ij} ) / {\sum }_{j = 1}^{M} {n}_{ij} ,$$
where vi is the video voltage of the ULR of the i-th test pattern; Mi is the number of different luminance in the NULR of the i-th test pattern; and nij and vij are the number of pixels and video voltage of the j-th luminance in the NULR of the i-th test pattern.

2. A method and apparatus as recited in claim 1, wherein the step(b) is replaced by requesting a user adjust the video input of the NULR for each test pattern so that the observed boundaries of the ULR and the NULR disappear.

3. A method and apparatus for visually measuring the chromatic characteristics of a display, measuring the characterization parameters of a given model R(v) of the tonal response curve for a primary of a display, which comprising the steps of:
setting a number of testing patterns in which each including two non-uniform luminance regions (NULRs), in which a NULR including interlaced pixels of different luminance;
requesting a user adjust the video input of a NULR for each test pattern so that the observed boundaries of the two NULRs disappear; and
computing the characterization parameters of the tonal response curve that most satisfy the set of equations:
$${\sum }_{j = 1}^{{M}_{1 i}} {n}_{1 ij} R ( {v}_{1 ij} ) / {\sum }_{j = 1}^{{M}_{1 i}} {n}_{1 ij} = {\sum }_{j = 1}^{{M}_{2 i}} {n}_{2 ij} R ( {v}_{2 ij} ) / {\sum }_{j = 1}^{{M}_{2 i}} {n}_{2 ij} ,$$
where, for the k-th NULR in the i-th test pattern, Mki is the number of different luminance; and nkij and vkij are the number of pixels and video voltage of the j-th luminance.

4. A method and apparatus for visually measuring the chromatic characteristics of a display, measuring the white point (xw, yw) of a color display based on selecting a neutral gray color of known chromaticity coordinate (xu, yu) from graphic user interfaces, in which the chromaticity coordinate of the neutral gray color is pre-determined by averaging the responses of a group of observers, which comprising the steps of:
(a)setting (xu, yu) and the chromaticity coordinates and tonal response curves of the primaries of the display; a trial white point of the display designated as (xwt, ywt); and the coordinate range of the chromaticity diagram to be shown in the next step, in which the central coordinate being (xc, yc);
(b)displaying a chromaticity diagram or a part of the chromaticity diagram on the display, in which the display being assumed to be of white point (xwt, ywt) and of the primaries given in step (a); and the luminance coordinate being the same for all pixels of the diagram;
(c)requesting a user select a pixel of neutral gray in the chromaticity diagram through a human-computer interaction device, in which the coordinate of the pixel being designated as (xus, yus); and
(d)computing (xw, yw) according to (xus, yus), (xwt, ywt), (xu, yu), and the chromaticity coordinates of the primaries of the display.

5. A method and apparatus as recited in claim 4, wherein the steps (b) and (c) are replaced by the following steps:
(I)setting the initial values, which being a coordinate (x′us, y′us)=(xc, yc), Δx, Δy, Nx, and Ny; and setting the condition for stopping the loop of selecting the neutral gray patch;
(II)setting (x0, y0)=(x′us, y′us);
(III)showing Nx×Ny color patches, in which each patch corresponding to a coordinate of (xi, yj, Y) in which xi and yj being arranged in an ordered fashion comprising a plurality of discrete coordinates nearby (x0, y0), Ax-spaced in x coordinate, and Δy-spaced in y coordinate; Y being the same for all color patches; and the video input of each color patch being generated so that its chromaticity coordinate being taken to be (xi, yj, Y) for the display which being assumed to be of white point (xwt, ywt) and of the primaries given in the step (a) of claim 4.;
(IV) requesting a user select a patch from the patches given in the step (III) through a human-computer interaction device, in which the patch looking the most close to neutral gray and the coordinate of this patch is designated as (x″us, y″us);
(V)going to step (f) if the difference of the coordinates (x″us, y″us) and (x′us, y′us) is less than a specified condition set in step (a), otherwise setting (x′us, y′us)=(x″us, y″us), reducing Δx and Δy, and going to step b; and
(VI)(xus, yus)=(x″us, y″us).

6. A method and apparatus as recited in claim 5, wherein the initial coordinate (x′us, y′us)=(xc, yc) is modified as (x′us, y′us)=(xus, yus).

7. A method as and apparatus recited in claim 4 or 5, wherein further comprises steps added in step (c) of claim 4 and step (VI) of claim 5 for guaranteeing the selection of neutral gray after completing the selection of a point of neutral gray or the selection of a color patch of neutral gray from the color patches, which comprising the steps of:
specifying the spaces δx and δy for the color coordinates of xus and yus;
displaying a box or a gray ramp showing the color of the selected neutral gray corresponding to (xus, yus) in claim 4, 5, or 6, in which the gray ramp including a sequence of small boxes with different gray levels; and
requesting a user change (xus, yus) with the spaces of δx and δy if the box or gray ramp in the last step until the box or gray ramp being observed to be neutral gray through a human-computer interface.

8. A method and apparatus for visually measuring the chromatic characteristics of a display, measuring the white point (xw, yw) of a color display based on selecting a neutral gray color of known chromaticity coordinate (xu, yu) from graphic user interfaces, in which the chromaticity coordinate of the neutral gray color being pre-determined by averaging the responses of a group of observers, which comprising the steps of:
(a)setting (xu, yu) and the chromaticity coordinates and tonal response curves of the primaries of the display; and the coordinate range of the chromaticity diagram to be shown in the next step, in which the central coordinate being (xwac, ywac);
(b)displaying a diagram on the display, in which the coordinate axes being designated as (xwa, ywa) and every chromaticity coordinate of the pixel in the diagram being taken to be (xu, yu, Y) for the display which being assumed to be of the white point (xwa, ywa) and of the primaries given in step (1), in which Y being the same for all pixels of the diagram;
(c)requesting a user select a point of neutral gray in the diagram through a human-computer interaction device, in which the coordinate of the selected neutral gray being designated as (xwas, ywas); and
(d)(xw, yw)=(xwas, ywas).

9. A method and apparatus as recited in claim 8, wherein the steps (b) and
(c) are replaced by the following steps:
(i)setting the initial values, which being a coordinate (x′was, y′was)=(xwac, ywac), Δx, Δy, Nx, and Ny; and setting the condition for stopping the loop of selecting the neutral gray patch;
(ii)setting (x0, y0)=(x′was, y′was);
(iii)showing Nx×Ny color patches, in which each patch corresponding to a coordinate of (xi, yj, Y) in which xi and yj being arranged in an ordered fashion comprising a plurality of discrete coordinates nearby (x0, y0), Δx-spaced in x coordinate, and Δy-spaced in y coordinate; Y being the same for all color patches; and the video input of each color patch being generated so that its chromaticity coordinate of the patch being taken to be (xu, yu, Y) for the display which being assumed to be of the white point (xi, yi) and of the primaries given in the step (a) of claim 8;
(iv)requesting a user select a color patch from the patches given in the step (c) through a human-computer interaction device, in which the patch looking the most close to neutral gray and the coordinate of this patch being designated as (x″was, y″was);
(v)going to step (vi) if the difference of the coordinates (x″was, y″was) and (x′was, y′was) being less than a specified condition set in step (a), otherwise setting (x′was, y′was)=(x″was, y″was), reducing Δx and Δy, and going to step (b); and
(vi)(xwas, ywas)=(x″was, y″was).

10. A method and apparatus as recited in claim 9, wherein the initial coordinate (x′was, y′was)=(xwac, ywac) is modified as (x′was, y′was) =(xwas, ywas).

11. A method and apparatus as recited in claim 8 or 9, wherein further comprises steps added in step (c) of claim 8 and step (vi) of claim 9 for guaranteeing the selection of neutral gray after completing the selection of a point of neutral gray on the diagram or the selection of a color patch of neutral gray from the color patches, which comprising the steps of:
specifying the spaces δx and δy for the color coordinates of xwas and ywas;
displaying a box or a gray ramp showing the color of the selected neutral gray corresponding to (xwas, ywas) in claim 8, 9, or 10, in which the gray ramp including a sequence of small boxes with different gray levels; and
requesting a user change (xwas, ywas) with the spaces of δx and δy if the box or gray ramp in the last step until the box or gray ramp being observed to be neutral gray through a human-computer interface.

12. A method and apparatus as recited in claim 4, wherein the preferred trial white point (xwt, ywt) designated as (0.3127, 0.3291).

13. A method and apparatus as recited in claim 4, wherein the preferred central coordinate (xc, yc) designated as the chromaticity coordinate of neutral gray (xu, yu).

14. A method and apparatus as recited in claim 8, wherein the preferred white point (xwac, ywac) designated as (0.3127, 0.3291).

15. A method and apparatus as recited in claim 7 or 11, wherein further comprises the arrow keys on a keyboard or a mouse with a graphic user interface which includes control symbols indicating the decrement and/or increment of chromaticity coordinates, in which a user click the symbols with the mouse to increase or decrease x and/or y coordinate.

16. A method and apparatus as recited in claim 15, wherein further comprises a position map in the graphic user interface for indicating the current position of the selected chromaticity coordinate with a highlight symbol in a coordinate system.
